(19) United States
(12) Patent Application Publication
(10) Pub. No.: US 2026/0296768 A1
(43) Pub. Date: Oct. 1, 2026

(54) STORAGE CART FOR THIN GLASS AND METHODS OF HANDLING THIN GLASS

(71) Applicant: CORNING INCORPORATED, CORNING, NY (US)

(72) Inventors: Gun-hoa Lee, Gwangju Metropolitan (KR); Eric James Shomo, Corning, NY (US)

(21) Appl. No.: 19/479,931

(22) PCT Filed: Jun. 21, 2024
(86) PCT No.: PCT/US2024/034891

§ 371 Date: Oct. 29, 2025

Related U.S. Application Data
(60) Provisional application No. 63/522,771, filed on Jun. 23, 2023.

(51) Int. Cl. B65D 85/48; B62B 3/10; B65D 25/10; B65G 49/06

(52) U.S. Cl. CPC B65D 85/48; B62B 3/108; B65D 25/107; B65G 49/063; B65G 2201/022

(57) ABSTRACT

A storage cart for thin glass that includes: a supporting frame comprising at least one opening, a rear face, two opposing sides, a top, and a bottom; a plurality of glass slots, each slot running from the at least one opening to the back of the frame and configured to accommodate one or more thin glass sheets having a thickness of less than 2.2 mm; and a plurality of sets of elastic strings arranged between the opposing sides of the frame. Each set of elastic strings defines the side of one of the glass slots. Further, each elastic string is coupled to the top and bottom of the frame and arranged in a slightly tilted orientation greater than 0°and less than or equal to 35° from vertical.

### CROSS-REFERENCE TO RELATED APPLICATIONS

This application claims the benefit of priority under 35 U.S.C. § 119 of U.S. Provisional Application No. 63/522,771 filed Jun. 23, 2023, the content of which is incorporated herein by reference in its entirety.

### FIELD OF THE DISCLOSURE

The disclosure relates to a storage cart for thin glass and, more particularly, a storage cart for thin glass used in insulated glass units and methods of handling and assembling such thin glass into insulated glass units (IGUs).

### BACKGROUND

Insulated glass units (IGUs) utilize two or more glass panes that are separated by a sealed air space. An IGU permits less thermal and sound transfer through the IGU than single pane glass units. Some IGUs include three panes of glass and two sealed air spaces between the three panes of glass. These IGUs are referred to as “triple-pane” IGUs. Triple-pane IGUs may become more prevalent as energy performance requirements of IGUs become more exacting in order to receive governmental performance certifications, such as the ENERGY STAR version 7 certification from the United States Environmental Protection Agency or the EU Energy Label certification from the European Union. The individual panes of glass of an IGU are sometimes made and cut to size from larger glass sheets.

Many insulated glass unit (IGU) designs can meet the new thermal requirements, but only drop-in triple-pane IGU designs can enable window makers to avoid costly retooling of their production lines. That is, these “drop-in” triple-pane IGUs advantageously have the same external dimensions as conventional triple-pane IGUs, but possess further internal design modifications (e.g., thinner glass) to meet the newer thermal requirements. Some thin triple-pane IGU solutions (<2.2 mm middle pane) are expected to win market share.

To enable the manufacturing of thin triple-pane products, IGU makers have a need for improved apparatuses and methods to store and move thin glass, particularly thin glass for use in triple-pane IGUs.

### SUMMARY

In one or more aspects of the present disclosure, configurations for retaining and supporting thin glass in large quantities is provided, where the cart (e.g., storage cart) is configured to promote alignment and support of the thin glass. As such, various embodiments promote thin glass which is retained in a configuration to promote improved reliability and retained quality of the thin glass, so that it can be incorporated into IGUs with high yield rates and minimal to no defects. As the inventors note that large sized, thin glass sheets (e.g. <2.2 mm in thickness) tend to bend under their own weight without specifically configured support and vertical (or near vertical stacking), the storage cart embodiments defined herein provide multi-faceted support to large quantities of thin glass, which then thereby reduces, prevents and/or eliminates thin glass susceptibilities to failures, defects, or other damages that would occur with conventional handling (i.e. without use of the storage cart embodiments provided herein).

According to an aspect of the disclosure, a storage cart for thin glass is provided that includes: a supporting frame comprising at least one opening, a rear face, two opposing sides, a top, and a bottom; a plurality of glass slots, each slot running from the at least one opening to the back of the frame and configured to accommodate one or more thin glass sheets having a thickness of less than 2.2 mm; and a plurality of sets of elastic strings arranged between the opposing sides of the frame. Each set of elastic strings defines the side of one of the glass slots. Further, each elastic string is coupled to the top and bottom of the frame and arranged in a slightly tilted orientation greater than 0° and less than or equal to 35° from vertical.

According to an aspect of the disclosure, a storage cart for thin glass is provided that includes: a supporting frame comprising at least one opening, a rear face, two opposing sides, a top, and a bottom; a plurality of glass slots, each slot running from the at least one opening to the back of the frame and configured to accommodate one or more thin glass sheets having a thickness of less than 2.2 mm; a plurality of sets of elastic strings arranged between the opposing sides of the frame; and a platform apparatus for indexing the one or more thin glass sheets in the plurality of glass slots. Each set of elastic strings defines the side of one of the glass slots.

Further, each elastic string is coupled to the top and bottom of the frame and arranged in a slightly tilted orientation greater than 0° and less than or equal to 35° from vertical.

According to an aspect of the disclosure, a storage cart for thin glass is provided that includes: a supporting frame comprising at least one opening and two opposing sides; a plurality of glass slots, each slot defined in part by the at least one opening and configured to accommodate one or more thin glass sheets having a thickness of less than 2.2 mm; and a plurality of sets of elastic strings arranged between the opposing sides of the frame. Each set of elastic strings defines the side of one of the glass slots. Further, each elastic string is coupled to the frame and arranged in a slightly tilted orientation greater than 0° and less than or equal to 35° from vertical.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the disclosure and the appended claims.

The accompanying drawings are included to provide a further understanding, and are incorporated in and constitute a part of this specification. The drawings illustrate one or more embodiment(s) and, together with the description, serve to explain, by way of example, principles and operation of the disclosure. It is to be understood that various features of the disclosure disclosed in this specification and in the drawings can be used in any and all combinations. By way of non-limiting examples, the various features of the disclosure may be combined with one another according to the following embodiments.

### BRIEF DESCRIPTION OF THE DRAWINGS

FIG. 1 is a system to process a glass sheet into one or more thin glass sheets, including a storage cart, according to one or more embodiments of the present disclosure;

FIG. 2A is a front view of a storage cart for thin glass, according to one or more embodiments of the present disclosure;

FIG. 2B is a side view of the storage cart of FIG. 2A;

FIG. 2C is a top view of a platform apparatus of the storage cart of FIG. 2A, according to one or more embodiments of the present disclosure;

FIG. 3 is a perspective view of a transfer unit of the system of FIG. 1 and the storage cart of FIG. 2A, according to one or more embodiments of the present disclosure; and

FIG. 4 is a flow chart of a method of handling thin glass, according to one or more embodiments of the present disclosure.

### DETAILED DESCRIPTION

In the following detailed description, for purposes of explanation and not limitation, example embodiments disclosing specific details are set forth to provide a thorough understanding of various principles of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

As used herein, the singular forms “a,” “an” and “the” include plural referents unless the context clearly dictates otherwise. Thus, for example, reference to a “component” includes aspects having two or more such components, unless the context clearly indicates otherwise.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an endpoint of a range, the disclosure should be understood to include the specific value or endpoint referred to. Whether or not a numerical value or endpoint of a range in the specification recites “about,” the numerical value or endpoint of a range is intended to include two embodiments: one modified by “about,” and one not modified by “about.” It will be further understood that the endpoints of each of the ranges are significant both in relation to the other endpoint, and independently of the other endpoint.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range was explicitly recited. As an illustration, a numerical range of “about 1 to about 5” should be interpreted to include not only the explicitly recited values of about 1 to about 5, but also to include individual values and sub-ranges within the indicated range. Thus, included in this numerical range are individual values such as 2, 3, and 4, the sub ranges such as from 1-3, from 2-4, from 3-5, etc., as well as 1, 2, 3, 4, and 5 individually. The same principle applies to ranges reciting only one numerical value as a minimum or maximum. Furthermore, such an interpretation should apply regardless of the breadth of the range or the characteristics being described by the range.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

Generally, the disclosure is directed to a storage cart for thin glass and, more particularly, a storage cart for thin glass used in IGUs and methods of handling such thin glass. These thin glass articles and sheets (<2.2 mm in thickness) are prone to bending under their own weight and are therefore more susceptible to failures and damage in handling and storage as compared to conventional glass sheets employed in IGUs. The storage carts of this disclosure, along with the methods of using them, are configured specifically to eliminate or otherwise minimize damage to these thin glass articles and sheets, particularly the thin glass employed in triple-pane IGUs configured for new thermal efficiency requirements.

More specifically, the storage carts of the disclosure are configured to hold a plurality of thin glass sheets in slots within a supporting frame. The slots are configured to minimize the number of contact points with each of the thin glass sheets loaded or otherwise stored in these slots. Further, the slots are defined by elastic strings, which are arranged in a slightly tilted orientation (0°<tilt angle≤35°) from vertical. This arrangement advantageously ensures that each of the thin glass sheets loaded or otherwise stored in the slots do not bend from their own weight.

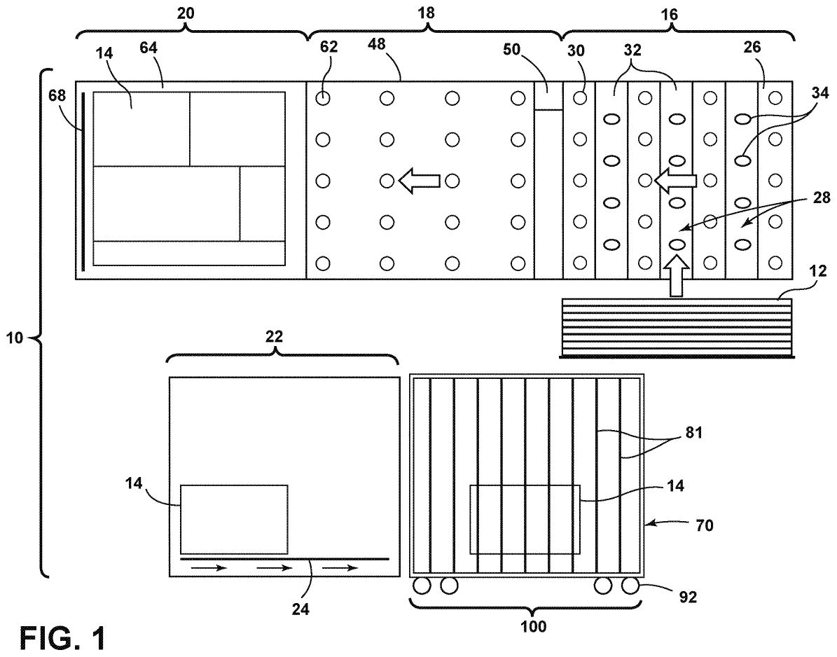

Referring to FIG. 1, a system 10 to process a thin glass sheet 12 into one or more thin glass articles 14 is depicted, according to an embodiment of the disclosure. The system 10 includes an unloading unit 16, a scoring unit 18, a breakout unit 20, a transfer unit 22, and a storage cart 100. The scoring unit 18 is downstream from the unloading unit 16. The breakout unit 20 is downstream from the scoring unit 18. The transfer unit 22 is downstream from the breakout unit 20.

As also depicted in FIG. 1, a storage cart 100, according to an embodiment of the disclosure, is downstream from the transfer unit 22. “Downstream,” for purposes of this disclosure, refers to the relative order of the components of the system 10 that the glass sheet 12 and the one or more glass articles 14 encounter during the processing of the glass sheet 12 into the one or more glass articles 14. The glass sheet 12 encounters the scoring unit 18 after encountering the unloading unit 16, and so on.

Referring again to FIG. 1, the unloading unit 16 includes a support table 26 with rows of wheels 30, and a glass sheet movement apparatus 28. The glass sheet movement apparatus 28 is configured to selectively affix itself to a glass sheet 12, move the glass sheet 12 onto or at least above the support table 26, and then release itself from the glass sheet 12. For example, the glass sheet movement apparatus 28 can include arms 32 and suction cups 34 disposed on each of the arms 32. Ultimately, the glass sheet movement apparatus 28 can move to, from, and between a resting position and a deployed position. Further, the apparatus 28 can employ its arms 32 and suction cups 34 to effect movement of the glass sheet 12 along the wheels 30 of the support table 26. In a resting position, the arms 32 of the glass sheet movement apparatus 28 are indexed between the rows of wheels 30, and can be disposed elevationally below the rows of wheels 30.

Still referring to FIG. 1, the scoring unit 18 includes a scoring table 48 and a scoring tool 50. The scoring table 48 is positioned to accept the glass sheet 12 from the support table 26 of the unloading unit 16. For example, the scoring table 48 can have a top surface that is relatively planar. The top surface of the scoring table 48 can be positioned slightly below the plane upon which the tangents of the wheels 30 of the support table 26 extend. Further, the scoring table 48 can be positioned in the direction that the wheels 30 of the support table 26 rotate towards. Thus, as the glass sheet 12 is rolled on the support table 26, the glass sheet 12 rolls toward and eventually onto the top surface of the scoring table 48.

The scoring tool 50, according to some embodiments, can be configured to score the glass sheet 12 disposed on the scoring table 48 according to predetermined dimensions for one or more glass articles 14. For example, the scoring tool 50 can include a scribing wheel (not shown) that is powered to rotate. When the scribing wheel contacts the glass sheet 12 upon the top surface of the scoring table 48, the scribing wheel removes material from the glass sheet 12. The scoring tool 50 can further include a gantry system (not shown) that translates the scribing wheel relative to the glass sheet 12 so that the scribing wheel can remove material from the glass sheet 12 along a scribe path according to the predetermined dimensions for the one or more glass articles 14. The predetermined dimensions that each of the one or more glass articles 14 should have can be set within an Enterprise Resource Planning (ERP) system (not shown). A controller in communication with the ERP system and the gantry system can manipulate the gantry system so that the scribe path is in accordance with the predetermined dimensions for the one or more glass articles 14, as established in the ERP system.

In embodiments of the system 10 depicted in FIG. 1, the scoring unit 18 further includes an air control system 62. The air control system 62 is configured to apply a suction force to the glass sheet 12 while the scoring tool 50 scores the glass sheet 12. For example, the air control system 62 can include a vacuum pump and apertures (not shown) through the scoring table 48 that are open at the top surface of the scoring table 48 and in fluid communication with the vacuum pump. When the vacuum pump is activated, air is drawn in through the apertures. The glass sheet 12 over the apertures becomes suction-locked in place. After the scoring tool 50 is finished scoring the glass sheet 12, the vacuum pump is deactivated, the negative pressure within the apertures is released, and the glass sheet 12 is no longer suction-locked to the top surface of the scoring table 48. In embodiments, the vacuum pump is activated but in reverse to blow air out of the apertures away from the top surface of the scoring table 48. The air lifts the glass sheet 12 upward away from the top surface of the scoring table 48 allowing the glass sheet 12 to be more easily moved to the breakout unit 20, as located downstream from the scoring unit 18.

Referring additionally to FIG. 1, the breakout unit 20, according to some embodiments, includes a breakout table 64. The breakout table 64 is positioned to accept the glass sheet 12 that has been scored from the scoring table 48 for separating into the one or more glass articles 14 from the glass sheet 12. For example, the breakout table 64 can have a top surface that is relatively planar and disposed adjacent to, but slightly elevationally below, the top surface of the scoring table 48. Thus, the glass sheet 12 (now scored) can be floated and/or slid from the top surface of the scoring table 48 directly onto the top surface of the breakout table 64. The breakout unit 20 can further include a flange 68 extending from the top surface of the breakout table 64. The flange 68 helps prevent the glass sheet 12 from sliding off the breakout table 64 to the ground.

Referring again to the breakout unit 20 depicted in FIG. 1, according to some embodiments, the breakout table 64 can be configured to move to, from, and between a position I (not shown) and a position II (not shown). In position I, the glass sheet 12 that has been scored (e.g., in the scoring unit 18) lies upon the breakout table 64 while the glass sheet 12 is separated into the one or more glass articles 14. For example, the top surface of the breakout table 64 in position I can be substantially horizontal. To segment the glass sheet 12 into the one or more glass articles 14, a force is applied along the scribe path that the scoring tool 50 imparted. The one or more glass articles 14 then separate along the scribe path. In position II, the breakout table 64 is oriented differently than position I. For example, in position II, the top surface of the breakout table 64 can be closer to vertical than in position I. The breakout table 64 can move between positions I and II by rotating. The breakout table 64 can be moved in a direction to position II such that the flange 68 extending from the top surface of the breakout table 64 is disposed closer to the ground than in position I. In position II, the one or more glass articles 14 can be positioned for movement to the transfer unit 22. The flange 68 prevents the one or more glass articles 14 from sliding off the breakout table 64 to the ground.

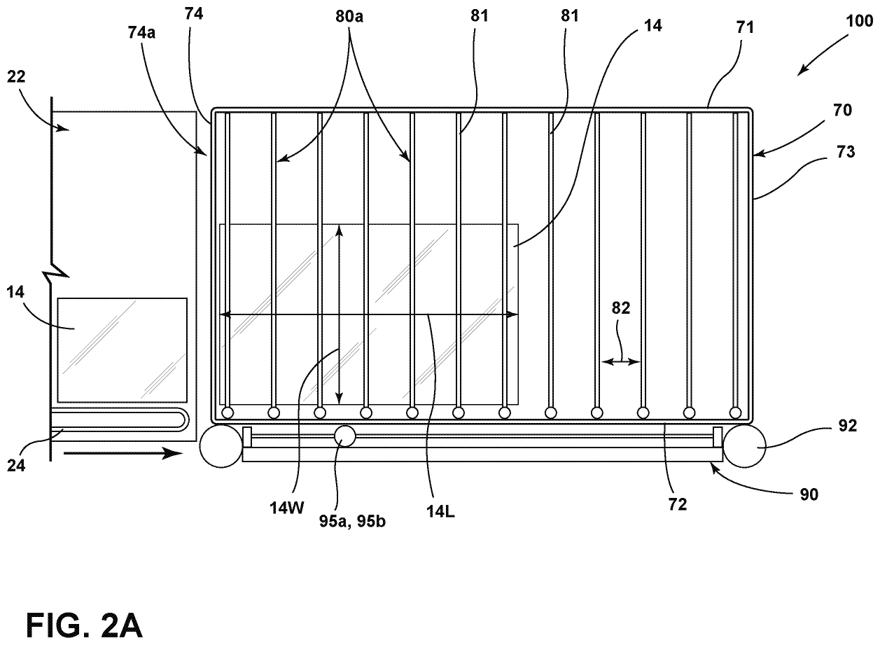

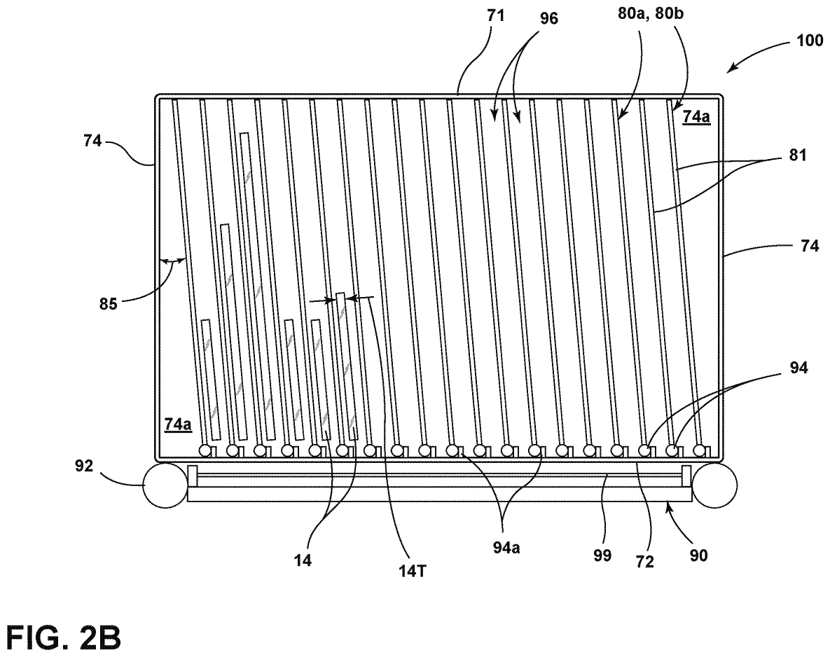

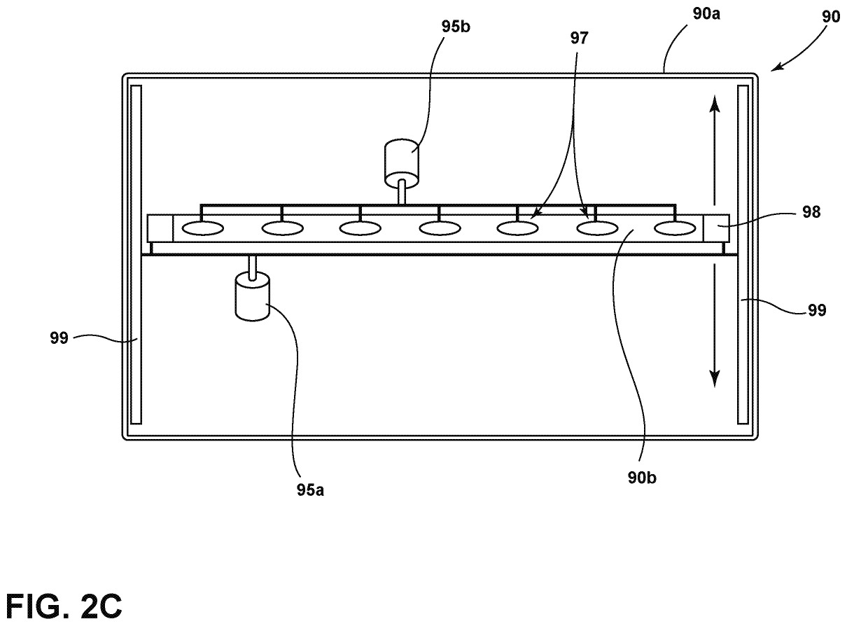

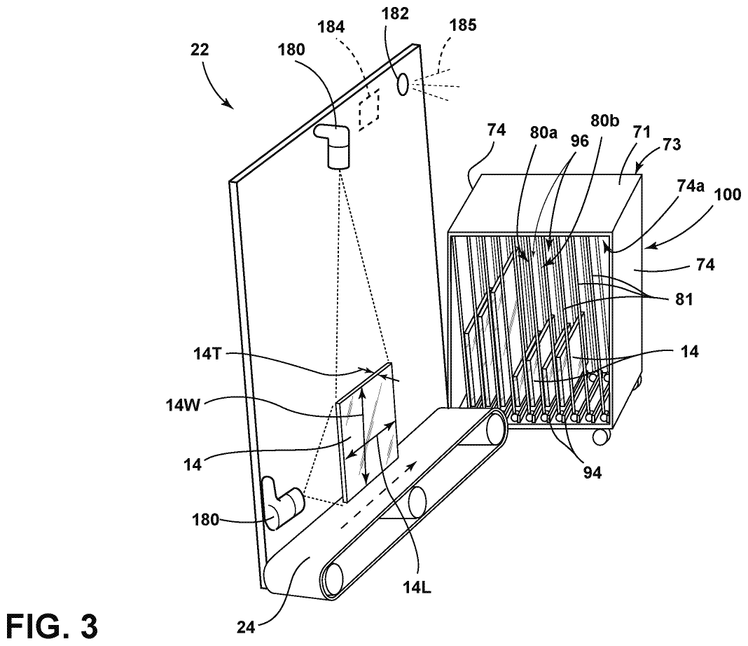

In embodiments of the system 10 depicted in FIG. 1, the transfer unit 22 can include a transfer conveyor 24 (see also FIG. 2A). An operator can move one of the one or more glass articles 14 from the breakout table 64 to the transfer conveyor 24 of the transfer unit 22. The transfer conveyor 24 can then move the glass article 14 toward the storage cart 100. Further, the transfer unit 22 can be configured in various arrangements as would be understood by those skilled in the field of the disclosure, including the configuration depicted in FIG. 3 (see below), to effect movement of the glass articles 14 on the transfer conveyor 24 to and into the storage cart 100.

Referring now to FIGS. 2A-2B, embodiments of the storage cart 100 (see also FIG. 1) are depicted in exemplary form. The storage cart 100 is configured for thin glass (<2.2 mm in thickness) and includes a supporting frame 70. In embodiments, the supporting frame 70 is constructed of a metal alloy (e.g., steel), polymer with suitable strength, composite or other suitable material for the application as understood by those skilled in the field of the disclosure. As shown in FIGS. 2A-2B, the supporting frame 70 includes an opening 74a, a rear face 73, two opposing sides 74, a top 71 and a bottom 72. In some implementations, the supporting frame 70 includes an opening in the rear face 73 (e.g., allowing for loading and unloading of thin glass articles 14); and in other implementations, the rear face 73 is substantially closed. Ultimately, the supporting frame 70 is configured to support, hold and move numerous thin glass articles 14, along with other supporting apparatus of the storage cart 100 (see below).

Referring again to FIGS. 2A-2B, the storage cart 100 is depicted as including a plurality of glass slots 96, which can accommodate one or more thin glass articles 14 having a thickness 14T of less than 2.2 mm. Each of the slots 96 runs from the opening 74a to the rear face 73 (or back) of the frame 70. As is also evident from FIGS. 2A-2B, each of the slots 96 is further defined by the top 71 and bottom 72 of the frame 70. In some implementations, the slots 96 run from the opening 74a to an opening in the rear face 73 of the frame 70. According to some implementations, the storage cart 100 includes from 25 to 250 slots 96, 25 to 200 slots 96, 25 to 150 slots 96, and all quantities of slots 96 between the foregoing endpoints, as configured for thin glass articles 14 having a thickness 14T of less than 2.2 mm. For example, the storage cart 100 can include 25, 30, 35, 40, 45, 50, 51, 52, 53, 54, 55, 56, 57, 58, 59, 60, 65, 70, 75, 80, 85, 90, 95, 100, 110, 120, 130, 140, 150, 160, 170, 180, 190, 200, 210, 220, 230, 240, or 250 slots 96.

Still referring to FIGS. 2A-2B, the storage cart 100 is depicted as including a plurality of sets 80a, 80b, and so on of elastic strings 81. That is, each set 80a, 80b, etc., of elastic strings 81 is arranged between opposing sides 74 of the supporting frame 70. Further, each set 80a, 80b, etc., of elastic strings 81 defines the side of one of the glass slots 96, running from the opening 74a to the rear face 73 of the frame 70. As such, each glass slot 96 is defined between two sets, e.g., sets 80a and 80b (see FIG. 2B), of elastic strings 81. According to some embodiments, each set 80a, 80b, etc., of the elastic strings 81 can be spaced from an adjacent set 80a, 80b, etc., by about 0.5 mm to 500 mm, 0.5 mm to 250 mm, or 0.5 mm to 200 mm, thus defining the width of a glass slot 96. For example, the width of each glass slot 96 can be 0.5 mm, 0.75 mm, 1 mm, 2 mm, 3 mm, 4 mm, 5 mm, 10 mm, 20 mm, 30 mm, 40 mm, 50 mm, 75 mm, 100 mm, 125 mm, 150 mm, 175 mm, 200 mm, 250 mm, 300 mm, 400 mm, 500 mm, and all values between these dimensions, as configured to accommodate thin glass articles 14 having a thickness of less than 2.2 mm. Accordingly, one or more thin glass articles 14 can be loaded into and unloaded from a glass slot 96, while minimally contacting the sets (e.g., 80a and 80b) of elastic strings 81. When the thin glass articles 14 are loaded into the storage cart 100, the glass articles 14 tend to rest on one set (e.g., 80a, 80b, etc.) of the elastic strings 81.

Referring again to the storage cart 100 depicted in FIGS. 2A-2B, each of the elastic strings 81 is coupled to the top 71 and bottom 72 of the frame 70. Further, each elastic string 81 is arranged in a slightly tilted orientation 85, from greater than 0° to less than or equal to 35° from vertical (i.e., the direction running parallel to the opening 74a and rear face 73). In some implementations, the orientation 85 of each of the elastic strings 81 is greater than 0° to less than or equal to 35°, 30°, 25°, 20°, 15°, and all orientations 85 between these values. For example, the orientation 85 of each of the elastic strings 81 can be 35°, 34°, 33°, 32°, 31°, 30°, 27.5°, 25°, 22.5°, 20°, 17.5°, 15°, 12.5°, 10°, 7.5°, 5°, and all orientations 85 between these values.

Advantageously, the slightly tilted orientation 85 of the elastic strings 81 of the storage cart 100 ensures that each glass slot 96 can support thin glass articles 14 having a thickness 14T of less than 2.2 mm. As noted earlier, thin glass articles 14, owing to their relative thinness, are more susceptible to bending from their own weight, even in a static condition, which can lead to damage and failure in handling and storage.

Referring again to the storage cart 100 depicted in FIGS. 2A-2B, according to some embodiments, suitable thin glass articles 14 have a thickness 14T of less than 2.2 mm and no restrictions on the length 14L and width 14W (other than any dimensional limitations associated with manufacturing, as understood by those skilled in the field of the disclosure). For example, the thickness 14T of the glass articles 14 employed in the storage cart 100 can be 2.1 mm, 2.0 mm, 1.9 mm, 1.8 mm, 1.7 mm, 1.6 mm, 1.5 mm, 1.4 mm, 1.3 mm, 1.2 mm, 1.0 mm, 0.9 mm, 0.8 mm, 0.7 mm, 0.6 mm, 0.5 mm, 0.4 mm, 0.3 mm, 0.2 mm, 0.1 mm, and all thicknesses 14T between these values. In certain implementations of the storage cart 100, each glass slot 96 is further configured to accommodate thin glass articles 14 having a width 14W and a length 14L, in which the width 14W ranges from 250 mm to 5000 mm or 250 nm to 3000 mm, and the length 14L ranges from 250 mm to 5000 mm or from 250 mm to 3000 mm. For example, the width 14W and/or length 14L of each of the thin glass articles 14 can be 250 mm, 500 mm, 750 mm, 1000 mm, 1250 mm, 1500 mm, 1750 mm, 2000 mm, 2250 mm, 2500 mm, 2700 mm, 2750 mm, 3000 mm, 3500 mm, 4000 mm, 4500 mm, 5000 mm, and all widths 14W and length 14L values between these dimensions (e.g., 2700 mm×2700 mm). Further, in some implementations of the storage cart 100, the thin glass articles 14 have a soda lime glass (SLG) composition, a composition suitable for architectural applications (e.g., Corning® Architectural Glass, Corning® Gorilla® glass, etc.), or another thin glass composition (e.g., Corning® Willow®) suitable for other applications, including IGUs.

Still referring to the storage cart 100 shown in FIGS. 2A-2B, according to some embodiments, each set 80a, 80b, etc., of the elastic strings 81 can include 10 to 150 elastic strings 81, 10 to 125 elastic strings 81, 10 to 100 elastic strings 81, or any number of elastic strings 81 between the foregoing endpoints. For example, each set 80a, 80b, etc., of the elastic strings can have 10, 20, 30, 40, 50, 60, 70, 80, 90, 100, 110, 120, 130, 140, or 150 elastic strings 81. In addition, as shown in these figures, each set 80a, 80b, etc., of the elastic strings can be defined by a predetermined or defined spacing 82 between each of the strings 81. Further, the spacing 82, according to some embodiments, can range from 2 to 30 inches, 2 to 20 inches, 2 to 15 inches, or any spacing value within the foregoing ranges. For example, the spacing 82 between the elastic strings 81 in a given set 80a, 80b, etc., of elastic strings can be set at 2, 3, 4, 5, 6, 7, 8, 9, 10, 12.5, 15, 20, 25, or 30 inches.

Referring again to FIGS. 2A-2B, the storage cart 100 includes sets 80a, 80b, etc., of elastic strings 81 configured to accommodate thin glass articles 14. In some embodiments, the elastic strings 81 are made of a natural or synthetic rubber or a polymeric material with suitable viscoelasticity to function as outlined in this disclosure. In some embodiments, each string 81 includes a sheathing (not shown) that substantially encapsulates a length of the string 81 between the top 71 and bottom 72 of the frame 70. Suitable sheathing materials have a low coefficient of friction, e.g., polytetrafluoroethylene (PTFE), polyvinyl chloride (PVC) or other comparable polymer. Further, the sheathing can be sized to allow rotation of the sheathing about the elastic string 81. Ultimately, the use of sheathing over the elastic strings 81 can, in some implementations, reduce friction and contact between the strings 81 and the thin glass articles 14 to reduce the potential for damage to the glass articles 14 and/or improve ease of movement of the glass articles 14 into and out of the glass slots 96 of the storage cart 100.

Still referring to FIGS. 2A-2B, embodiments of the storage cart 100 can include various additional features to enable or otherwise improve its function in moving, storing and/or handling thin glass articles 14. In some embodiments, the storage cart 100 further includes a plurality of wheels 92 coupled to the bottom 72 of the supporting frame 70. In these embodiments, the wheels 92 are configured to enable and facilitate free motion of the storage cart 100. Accordingly, the wheels 92 can be constructed in various forms and materials (e.g., rubber-coated PVC) to serve the intended function.

According to another implementation of the storage cart 100 depicted in FIGS. 2A-2B, the cart can further include a plurality of rollers 94 within some or all of the glass slots 96. In these implementations, each roller 94 is coupled to the bottom 72 of the frame 70 and configured for loading and unloading of the thin glass article 14 into and out of the slot 96 in which it resides. Advantageously, the use of multiple rollers 94 within each slot 96 can minimize the amount of friction and contact between the thin glass articles 14 and the elastic strings 81 defining the slot 96. Accordingly, less friction and contact with the glass articles 14 can improve ease of motion for the articles 14 and minimize the introduction of defects into the glass articles 14 through excessive contact from handling.

According to another embodiment of the storage cart 100 depicted in FIGS. 2A-2B, the cart can further include one or more proximity sensors 94a within some or all of the glass slots 96. Each sensor 94a is coupled to the bottom 72 of the supporting frame 70 and is configured for sensing the thin glass articles 14 within the slot 96 in which the sensor 94a resides. In some embodiments, each of the proximity sensors 94a can detect whether the glass slot 96 in which the sensor(s) 94a reside has one or more thin glass articles 14 in a loaded or unloaded condition.

Referring now to FIG. 2C, embodiments of the storage cart 100 can further include a platform apparatus 90, which can index the thin glass articles 14 in the plurality of glass slots 96 (see also FIGS. 2A-2B). In embodiments, the platform apparatus 90 is located beneath (and, in some embodiments, coupled to) the bottom 72 of the supporting frame 70 (see also FIGS. 2A-2B). As also depicted in exemplary form in FIG. 2C, the platform apparatus 90 includes a platform frame 90a, one or more index motors 95a, and one or more roller motors 95b. Each of the motors 95a, 95b is coupled to a platform 90b running the length of the platform apparatus 90 (e.g., in the same direction as from the opening 74a to the rear face 73 of the supporting frame 70); and the platform 90b is coupled to the platform frame 90a. Further, the platform 90b containing the motors 95a, 95b can be coupled to a pair of belts 99 located in proximity to the respective front opening 74a and rear face 73 of the supporting frame 70. These belts 99 facilitate motion of the platform apparatus 90, particularly the platform frame 90a, in the width direction of the storage cart 100 between the sides 74 of the supporting frame 70. In addition, as shown in FIG. 2C, the platform 90b can include a plurality of drive rollers 97 and a lifting mechanism 98. In some embodiments of the storage cart 100, the lifting mechanism 98 can include one or more hydraulic assemblies and components, or other suitable lifting apparatus as understood by those skilled in the field of the disclosure.

In operation (whether manually by an operator or automated or semi-automated through control by an ERP system), the platform apparatus 90 of the storage cart 100 depicted in FIG. 2C can index thin glass articles 14 into and out of the glass slots 96 of the cart. The index motor 95a (or multiple index motors 95a), for example, can be activated to move the platform 90b between the sides 74 of the frame 70 of the cart 100 in the width direction using the belts 99 and into alignment below a designated glass slot 96. At this point, the lifting mechanism 98 can be activated to move the platform 90b in the vertical direction within the glass slot 96 such that the drive rollers 97 are substantially in the same plane as the rollers 94 in the given glass slot 96. The roller motor 95b or multiple roller motors 95b can then be activated to engage the drive rollers 97 to move a thin glass article 14 into or out of the glass slot 96 within the storage cart 100. As the glass articles 14 are moved in this manner, the articles also are in contact with the rollers 94 present in each slot 96. After the desired movement of the thin glass article 14 within the glass slot 96 (e.g., into or out of the slot 96 as indicated by the proximity sensors 94a), the lifting mechanism 98 can be engaged to drop the platform 90b downward out of the glass slot 96. The foregoing process can be repeated, with the platform apparatus 90 engaged again to index another thin glass article 14 into or out of another glass slot 96.

Referring now to FIG. 3, the transfer unit 22 of the system 10 (see FIG. 1) can, according to some embodiments, include a transfer conveyor 24, one or more glass dimension sensors 180, and an alarm 182. An operator can move one of the one or more thin glass articles 14 from the breakout table 64 to the transfer conveyor 24. The one or more glass dimension sensors 180 are configured to generate output that changes as a function of the dimensions (e.g., a length 14L, a width 14W, and a thickness 14T) of the glass article 14 disposed on the transfer conveyor 24. Each of the one or more glass dimension sensors 180 can be positioned to ascertain a different one of the major dimensions of the glass article 14 (e.g., one glass dimension sensor 180 measures the length 14L, another glass dimension sensor 180 measures the width 14W, and another glass dimension sensor 180 measures the thickness 14T). In this embodiment, the one or more glass dimension sensors 180 are in communication with a controller 184. The controller 184, using the output of the one or more glass dimension sensors 180, can determine the dimensions of the thin glass article 14.

In some embodiments of the transfer unit 22, as depicted in FIG. 3, the controller 184 is in further communication with the alarm 182. The controller 184 compares the dimensions of the thin glass article 14 to predetermined dimensions for the glass article 14 as established in the ERP. If the controller 184 determines that the dimensions of the thin glass article 14 are outside of a predetermined tolerance from the predetermined dimensions as established in the ERP, then the controller 184 causes the alarm 182 to alert (e.g., issue an audible or visual notification 185) the operator of the system 10 that the glass article 14 has unacceptable dimensions. The operator can then take corrective action. The alarm 182 is configured to issue that alert. For example, the alarm 182 can emit a flashing light or an audible noise, among other options. The transfer conveyor 24 can the move the thin glass article 14 toward the storage cart 100 (see also FIGS. 2A-2C).

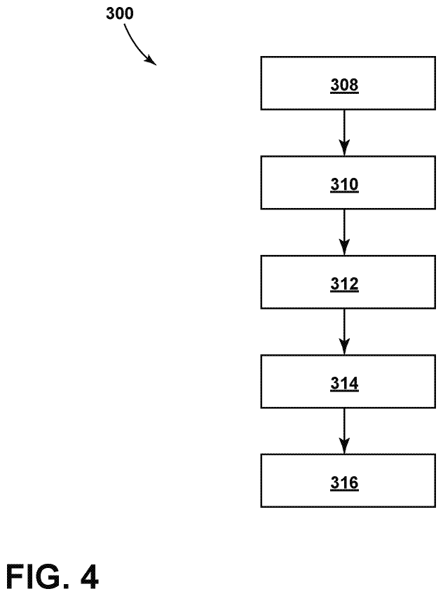

Referring now to FIG. 4, a flow chart is provided of a method 300 of handling thin glass articles 14, e.g., a method that utilizes a storage cart 100 (see FIGS. 1-3). According to the method 300, a dimensions-checking step 308 can be conducted with the transfer unit 22 (see FIG. 3 and corresponding description). In particular, the dimensions-checking step 308 can include a determination of whether a given thin glass article 14 has dimensions (e.g., 14L, 14W and 14T) within a predetermined tolerance of predetermined dimensions. As detailed above, one or more dimension sensors 180 in the transfer unit 22 can be used for conducting the dimensions-checking step 308 of the method 300.

In embodiments of the method 300 depicted in FIG. 4, the dimensions-checking step 308 occurs while the glass article 14 is on the transfer conveyor 24 of the transfer unit 22. After the glass sheet 12 is separated into the one or more thin glass articles 14, such as at the breakout table 64, each glass article 14 can be transported to the transfer conveyor 24, where the dimensions of the glass article 14 placed thereupon are determined via output of the one or more glass dimension sensors 180. The dimensions of the glass article 14 may be the same (or within predetermined tolerance, such as 1%) as predetermined dimensions for glass article 14. If the dimensions of the glass article 14 are determined to be correct, then the method 300 proceeds to the indexing step 310. The predetermined dimensions, and the tolerances, for each of the glass articles 14 can be set within the ERP. Alternatively, an operator can manually input the measured dimensions of each glass article 14 into the ERP.

Referring again to FIG. 4, the method 300 includes an indexing step 310. In the indexing step 310, a platform apparatus 90 of the storage cart 100 can be moved within the storage cart 100 to a particular glass slot 96 in view of the dimensions of the thin glass article 14 determined in the preceding dimensions-checking step 308. That is, certain glass slots 96 of the storage cart 100, for example, can be dedicated by the ERP for particular dimensions or ranges of dimensions of the glass articles 14. Further, during the indexing step 310, the platform apparatus 90 (or an alternative apparatus with the same or similar function) can be engaged to move within the glass slot 96 (e.g., in the vertical direction) to ensure that its driving apparatus can engage with the thin glass article 14 on the conveyor 24 in the transfer unit 22.

The method 300 shown in FIG. 4 also includes a loading step 312. In this step, the glass article 14 on the conveyor 24 in the transfer unit 22 can be loaded into a designated glass slot 96 within the storage cart 100, either manually or by operation of a platform apparatus 90. The particular slot 96 into which a particular thin glass article 14 is to be loaded can be established in the ERP, or an operator can inform the ERP of the slot 96 into which the operator has loaded the glass article 14. Further, it should be understood that steps 308-312 can be repeated according to the method 300 to load a collection of thin glass articles 14 into the storage cart 100.

In addition, the method 300 can include an additional moving step 314 for moving the cart 100 and an additional unloading step 316 for unloading one or more of the thin glass articles 14. For example, the storage cart 100 can be moved by an operator or a robot in the moving step 314 by the engagement of the wheels 92 on the underside of the cart 100. Further, the unloading step 316 can be conducted in a manner similar to the loading step 312, and the glass articles 14 can be unloaded by an operator and/or through the direction of an ERP for various purposes, e.g., long-term storage of the thin glass articles 14, assembly of the thin glass articles 14 into IGUS, etc.

Referring again to the platform apparatus 90 depicted in exemplary form in FIG. 3, it is envisioned that other apparatus can be employed with the storage cart 100 of FIGS. 2A-2C with the same or similar function (e.g., to index, load and unload glass articles 14). For example, the platform apparatus 90 could be configured with nearly the same components to reside on the top of the storage cart 100, above the top 71 of the frame 70. In another embodiment, a platform apparatus 90 could be modified to include an air cylinder or similar device as a replacement or as a modification to the platform 90b and its components (see FIG. 2C and earlier description). Such an air cylinder could be indexed into a glass slot 96 using the platform apparatus 90, and then the air cylinder rather than the drive rollers 97 could be directed to engage the glass article 14 (e.g., through suction) and move it into or out of the glass slot 96. As another embodiment, the pair of belts 99 of the platform apparatus 90 could be replaced with a chain or sprocket arrangement (e.g., a configuration similar to a bicycle chain), which could also function to move the platform 90b to the desired glass slot 96 within the storage cart 100 by operation of the index motor 95a.

Referring again to the storage cart 100 depicted in FIGS. 2A-2C and detailed earlier, it is also envisioned that simplified versions of the cart could also possess the same benefits and advantageous functionality. For example, a storage cart consistent with the principles of this disclosure and the cart 100 depicted in exemplary form in FIGS. 2A-2C can be configured with a supporting frame 70 comprising at least one opening 74a and two opposing sides 74. In this configuration, the shape of the cart and its frame is not substantially limited. For example, the frame of this cart could be cube, rectangular, cylindrically, or spherically shaped. The cart 100 is envisioned to include a plurality of glass slots 96, with each slot 96 defined in part by the at least one opening 74a and configured to accommodate one or more thin glass sheets or articles 14 having a thickness of less than 2.2 mm. In this configuration, the cart also includes a plurality of sets 80a, 80b, etc., of elastic strings 81 arranged between the opposing sides of the frame. Each set 80a, 80b, etc., of elastic strings 81 defines the side of one of the glass slots 96. Further, each elastic string 81 is coupled to the frame 70 (regardless of its shape) and arranged in a slightly tilted orientation 85 greater than 0° and less than or equal to 35° from vertical. However, it should also be understood that other apparatus and features of this cart can be incorporated from the storage cart 100 detailed earlier and depicted in exemplary form in FIGS. 2A-2C.

The various features described in the specification may be combined in any and all combinations, for example, as listed in the following embodiments.

Embodiment 1. According to an aspect of the disclosure, a storage cart for thin glass is provided that includes: a supporting frame comprising at least one opening, a rear face, two opposing sides, a top, and a bottom; a plurality of glass slots, each slot running from the at least one opening to the back of the frame and configured to accommodate one or more thin glass sheets having a thickness of less than 2.2 mm; and a plurality of sets of elastic strings arranged between the opposing sides of the frame. Each set of elastic strings defines the side of one of the glass slots. Further, each elastic string is coupled to the top and bottom of the frame and arranged in a slightly tilted orientation greater than 0° and less than or equal to 35° from vertical.

Embodiment 2. The storage cart of Embodiment 1 is provided, wherein each set of elastic strings comprises from ten (10) to one hundred (100) strings, each string spaced from 2 inches to 20 inches from another string in the set.

Embodiment 3. The storage cart of Embodiment 1 or Embodiment 2 is provided, wherein each set of strings is spaced from an adjacent set of strings by 0.5 mm to 200 mm to define one of the glass slots.

Embodiment 4. The storage cart of any one of Embodiments 1-3 is provided, wherein each string comprises a sheathing that substantially encapsulates a length of the string between the top and the bottom of the frame.

Embodiment 5. The storage cart of any one of Embodiments 1-4 is provided, wherein each glass slot is further configured to accommodate one or more thin glass sheets comprising a width ranging from 250 mm to 5000 mm and a length ranging from 250 mm to 5000 mm.

Embodiment 6. The storage cart of any one of Embodiments 1-5 is provided, further comprising a plurality of wheels coupled to the bottom of the frame, wherein the wheels are configured for free motion of the storage cart.

Embodiment 7. The storage cart of any one of Embodiments 1-6 is provided, further comprising a plurality of rollers in each glass slot, each roller coupled to the bottom of the frame and configured for loading and unloading of the one or more glass sheets into and out of the glass slot.

Embodiment 8. The storage cart of any one of Embodiments 1-7 is provided, further comprising a proximity sensor in each glass slot, each sensor coupled to the bottom of the frame and configured for sensing the one or more glass sheets within the glass slot in loaded and unloaded conditions.

Embodiment 9. According to an aspect of the disclosure, a storage cart for thin glass is provided that includes: a supporting frame comprising at least one opening, a rear face, two opposing sides, a top, and a bottom; a plurality of glass slots, each slot running from the at least one opening to the back of the frame and configured to accommodate one or more thin glass sheets having a thickness of less than 2.2 mm; a plurality of sets of elastic strings arranged between the opposing sides of the frame; and a platform apparatus for indexing the one or more thin glass sheets in the plurality of glass slots. Each set of elastic strings defines the side of one of the glass slots. Further, each elastic string is coupled to the top and bottom of the frame and arranged in a slightly tilted orientation greater than 0° and less than or equal to 35° from vertical.

Embodiment 10. The storage cart of Embodiment 9 is provided, wherein each set of elastic strings comprises from ten (10) to one hundred (100) strings, each string spaced from 2 inches to 20 inches from another string in the set.

Embodiment 11. The storage cart of Embodiment 9 or Embodiment 10 is provided, wherein each set of strings is spaced from an adjacent set of strings by 0.5 mm to 200 mm to define one of the glass slots.

Embodiment 12. The storage cart of any one of Embodiments 9-11 is provided, wherein each string comprises a sheathing that substantially encapsulates a length of the string between the top and the bottom of the frame.

Embodiment 13. The storage cart of any one of Embodiments 9-12 is provided, wherein each glass slot is further configured to accommodate one or more thin glass sheets comprising a width ranging from 250 mm to 5000 mm and a length ranging from 250 mm to 5000 mm.

Embodiment 14. The storage cart of any one of Embodiments 9-13 is provided, further comprising a plurality of wheels coupled to the bottom of the frame, wherein the wheels are configured for free motion of the storage cart.

Embodiment 15. The storage cart of any one of Embodiments 9-14 is provided, further comprising a plurality of rollers in each glass slot, each roller coupled to the bottom of the frame and configured for loading and unloading of the one or more glass sheets into and out of the glass slot.

Embodiment 16. The storage cart of any one of Embodiments 9-15 is provided, further comprising a proximity sensor in each glass slot, each sensor coupled to the bottom of the frame and configured for sensing the one or more glass sheets within the glass slot in loaded and unloaded conditions.

Embodiment 17. The storage cart of any one of Embodiments 9-16 is provided, wherein the platform apparatus is coupled to the bottom of the supporting frame and is configured for motion between the sides of the frame and into and out of each of the glass slots.

Embodiment 18. The storage cart of Embodiment 17 is provided, wherein the platform apparatus comprises at least one drive roller for loading and unloading the one or more thin glass sheets into and out of one of the glass slots.

Embodiment 19. According to an aspect of the disclosure, a storage cart for thin glass is provided that includes: a supporting frame comprising at least one opening and two opposing sides; a plurality of glass slots, each slot defined in part by the at least one opening and configured to accommodate one or more thin glass sheets having a thickness of less than 2.2 mm; and a plurality of sets of elastic strings arranged between the opposing sides of the frame.

Each set of elastic strings defines the side of one of the glass slots. Further, each elastic string is coupled to the frame and arranged in a slightly tilted orientation greater than 0°and less than or equal to 35° from vertical.

Embodiment 20. The storage cart of Embodiment 19 is provided, wherein each set of elastic strings comprises from ten (10) to one hundred (100) strings, each string spaced from 2 inches to 20 inches from another string in the set.

Embodiment 21. The storage cart of Embodiment 19 or Embodiment 20 is provided, wherein each set of strings is spaced from an adjacent set of strings by 0.5 mm to 200 mm to define one of the glass slots.

Embodiment 22. The storage cart of any one of Embodiments 19-21 is provided, wherein each string comprises a sheathing that substantially encapsulates a length of the string.

Embodiment 23. The storage cart of any one of Embodiments 19-22 is provided, wherein each glass slot is further configured to accommodate one or more thin glass sheets comprising a width ranging from 250 mm to 5000 mm and a length ranging from 250 mm to 5000 mm.

Embodiment 24. The storage cart of any one of Embodiments 19-23 is provided, further comprising a plurality of rollers in each glass slot, each roller coupled to the frame and configured for loading and unloading of the one or more glass sheets into and out of the glass slot.

Embodiment 25. The storage cart of any one of Embodiments 19-24 is provided, further comprising a proximity sensor in each glass slot, each sensor coupled to the frame and configured for sensing the one or more glass sheets within the glass slot in loaded and unloaded conditions.

1. A storage cart for thin glass, comprising:
a supporting frame comprising at least one opening, a rear face, two opposing sides, a top, and a bottom;
a plurality of glass slots, each glass slot of the plurality of glass slots running from the at least one opening to the back of the supporting frame and configured to accommodate one or more thin glass sheets having a thickness of less than 2.2 mm; and
a plurality of sets of elastic strings arranged between the two opposing sides of the supporting frame,
wherein each set of elastic strings defines a side of the two opposing sides of at least one glass slot of the plurality of glass slots, and
further wherein each elastic string is coupled to the top and bottom of the supporting frame and arranged in a slightly tilted orientation greater than 0° and less than or equal to 35° from vertical.

2. The storage cart of claim 1, wherein each set of elastic strings comprises from ten (10) to one hundred (100) elastic strings, each elastic string spaced from 2 inches to 20 inches from another elastic string in the set of elastic strings.

3. The storage cart of claim 1, wherein each set of elastic strings is spaced from an adjacent set of elastic strings by 0.5 mm to 200 mm to define at least one glass slot of the plurality of glass slots.

4. The storage cart of claim 1, wherein each elastic string comprises a sheathing that substantially encapsulates a length of the elastic string between the top and the bottom of the supporting frame.

5. (canceled)

6. The storage cart of claim 1, further comprising:
a plurality of wheels coupled to the bottom of the supporting frame, wherein the plurality of wheels are configured for free motion of the storage cart.

7. The storage cart of claim 1, further comprising:
a plurality of rollers in each glass slot of the plurality of glass slots, each roller of the plurality of rollers coupled to the bottom of the supporting frame and configured for loading and unloading of the one or more thin glass sheets into and out of the corresponding glass slot.

8. The storage cart of claim 1, further comprising:
a proximity sensor in each glass slot of the plurality of glass slots, each proximity sensor coupled to the bottom of the supporting frame and configured for sensing the one or more thin glass sheets within the corresponding glass slot in loaded and unloaded conditions.

9. A storage cart for thin glass, comprising:
a supporting frame comprising at least one opening, a rear face, two opposing sides, a top, and a bottom;
a plurality of glass slots, each glass slot of the plurality of glass slots running from the at least one opening to the back of the supporting frame and configured to accommodate one or more thin glass sheets having a thickness of less than 2.2 mm;
a plurality of sets of elastic strings arranged between the two opposing sides of the supporting frame; and
a platform apparatus for indexing the one or more thin glass sheets in the plurality of glass slots,
wherein each set of elastic strings defines a side of the two opposing sides of one of the plurality of glass slots, and
further wherein each elastic string is coupled to the top and bottom of the supporting frame and arranged in a slightly tilted orientation greater than 0° and less than or equal to 35° from vertical.

10. The storage cart of claim 9, wherein each set of elastic strings comprises from ten (10) to one hundred (100) elastic strings, each elastic string spaced from 2 inches to 20 inches from another elastic string in the set of the elastic strings.

11. The storage cart of claim 9, wherein each set of elastic strings is spaced from an adjacent set of elastic strings by 0.5 mm to 200 mm to define one of the plurality of glass slots.

12. (canceled)

13. The storage cart of claim 9, wherein each glass slot of the plurality of glass slots is further configured to accommodate the one or more thin glass sheets comprising a width ranging from 250 mm to 5000 mm and a length ranging from 250 mm to 5000 mm.

14. The storage cart of 9, further comprising:
a plurality of wheels coupled to the bottom of the supporting frame, wherein the plurality of wheels are configured for free motion of the storage cart.

15. (canceled)

16. The storage cart of claim 9, further comprising:
a proximity sensor in each glass slot of the plurality of glass slots, each proximity sensor coupled to the bottom of the supporting frame and configured for sensing the one or more thin glass sheets within the corresponding glass slot in loaded and unloaded conditions.

17. The storage cart of claim 9, wherein the platform apparatus is coupled to the bottom of the supporting frame and is configured for motion between the two opposing sides of the supporting frame and into and out of each of the plurality of glass slots.

18. The storage cart of claim 17, wherein the platform apparatus comprises at least one drive roller for loading and unloading the one or more thin glass sheets into and out of one of the plurality of glass slots.

19. A storage cart for thin glass, comprising:
a supporting frame comprising at least one opening and two opposing sides;
a plurality of glass slots, each glass slot of the plurality of glass slots defined in part by the at least one opening and configured to accommodate one or more thin glass sheets having a thickness of less than 2.2 mm; and
a plurality of sets of elastic strings arranged between the two opposing sides of the supporting frame,
wherein each set of elastic strings defines a side of the two opposing sides of one of the plurality of glass slots, and
further wherein each elastic string is coupled to the supporting frame and arranged in a slightly tilted orientation greater than 0° and less than or equal to 35° from vertical.

20. The storage cart of claim 19, wherein each set of elastic strings comprises from ten (10) to one hundred (100) elastic strings, each elastic string spaced from 2 inches to 20 inches from another elastic string in the set of elastic strings.

21. The storage cart of claim 19, wherein each set of elastic strings is spaced from an adjacent set of elastic strings by 0.5 mm to 200 mm to define one of the plurality of glass slots.

22. (canceled)

23. (canceled)

24. The storage cart claim 19, further comprising:
a plurality of rollers in each glass slot of the plurality of glass slots, each roller coupled to the supporting frame and configured for loading and unloading of the one or more thin glass sheets into and out of the corresponding glass slot.

25. The storage cart of claim 19, further comprising:
a proximity sensor in each glass slot of the plurality of glass slots, each proximity sensor coupled to the supporting frame and configured for sensing the one or more thin glass sheets within the corresponding glass slot in loaded and unloaded conditions.
